(19) United States
(12) Patent Application Publication
(10) Pub. No.: US 2008/0113074 A1
(43) Pub. Date: May 15, 2008

(54) Sweetener Compositions with a Sweetness and Taste Profile Comparable to HFCS 55

(76) Inventors: Susanne RATHJEN, Darmstadt (DE); Suzanne Schwarz, Frankfurt (DE)

Correspondence Address: PROPAT, L.L.C., 425-C SOUTH SHARON AMITY ROAD, CHARLOTTE, NC, 28211-2841, US

(21) Appl. No.: 11/939,598

(22) Filed: Nov. 14, 2007

Related U.S. Application Data
(63) Continuation of application No. 11/035,590, filed on Jan. 14, 2005, now abandoned.

(51) Int. Cl. A23L 1/236

(52) U.S. Cl. 426/548

(57) ABSTRACT

This invention relates to sweetening compositions used to produce foodstuffs with a sweetness and taste profile comparable to HFCS 55. The sweetener compositions generally include at least one carbohydrate sweetener selected from the group consisting of HFCS 55, HFCS 42 and sucrose along with an effective amount of a high intensity sweetener composition. The high intensity sweetener composition includes acesulfame K, aspartame and sucralose. Foodstuffs formed using the reduced-calorie sweetener compositions of the invention exhibit a taste profile comparable to HFCS 55 and a calorie reduction of 50% or more.

### CROSS-REFERENCE TO RELATED APPLICATIONS

This application is a continuation of co-pending U.S. application Ser. No. 11/035,590 filed Jan. 14, 2005. Co-pending U.S. application Ser. No. 11/035,590 is hereby incorporated by reference herein in its entirety.

### FIELD OF THE INVENTION

The present invention relates to sweetener compositions. More particularly, the present invention relates to sweetener compositions used to produce reduced calorie beverages having a sweetness and taste profile comparable to beverages incorporating high fructose corn syrup alone.

### BACKGROUND OF THE INVENTION

Carbohydrates have historically been used to impart sweetness to a variety of foodstuffs such as beverages and the like. Unfortunately, carbohydrate sweeteners are highly caloric. Conventional carbohydrate sweeteners include sucrose, derived from sugar cane or sugar beets, and high fructose corn syrups (“HFCSs”).

HFCSs are common liquid sweeteners formed from isomerized corn syrups derived from the isomerization of glucose in the syrup to fructose by the enzyme isomerase. HFCSs are typically available as either HFCS 42, containing 42% fructose, or HFCS 55, containing 55% fructose. The taste profiles of these two HFCSs differ from each other. The taste profiles of both of these HFCSs differ from sugar, as well. Nevertheless, HFCSs are commonly incorporated into a wide variety of foods and beverages instead of sugar, primarily for cost reasons. HFCS 42 is more economical in comparison to HFCS 55. However, amongst HFCSs, it is well accepted that the taste quality, i.e. sweetness level, of HFCS 55 is superior to HFCS 42. Consequently, HFCS 55 is regarded as a sweetness standard in certain regions and product categories.

In contrast to carbohydrate sweeteners, high intensity sweeteners are synthetic or natural substances which have either no calories or minimal, e.g. virtually no calories. As the name suggests, high intensity sweeteners exhibit a sweetness potency several times higher than sugar. High intensity sweeteners or blends of high intensity sweeteners are used in food and beverages to achieve a sweet taste without adding substantial calories to the products. High intensity sweeteners commonly employed include acesulfame K, alitame, aspartame, cyclamate, lo han go, neohesperidine dihydrochalcone, neotame, saccharin, stevioside and sucralose.

The ongoing debate on obesity in developed countries and the growing health consciousness of consumers has lead to an increasing demand for reduced-calorie beverages that exhibit a taste profile similar to beverages sweetened with carbohydrate sweeteners. More specifically, there is a demand for beverages that have more than a 50% reduction in calories compared to products fully sweetened with carbohydrates. Consumers prefer that such reduced calorie beverages further exhibit an overall taste profile similar to the sweetness standard HFCS 55.

However, no high-intensity sweetener alone matches the taste profile of HFCS 55 completely. They differ in characteristics such as sweetness profile, side taste and off-taste characteristics. Proper blending of different high intensity sweeteners is known to overcome part of the taste limitations of single high-intensity sweeteners, however, even mixtures of high intensity sweeteners can not match the overall taste sensation of HFCS 55. In particular, even if a more HFCS 55-like sweetness profile is achieved in products with only high-intensity sweeteners alone, they still can be distinguished sensorically from HFCS 55 by lack of mouthfeel and reduced flavor characteristics.

Fry (“Sugar Replacement in Non-diet Soft Drinks”, Food Technology International Europe, 83-86, 1995) describes a 30 and 50% calorie reduction in cola and lemonades using combinations of either (a) glucose syrup and aspartame or (b) low-fructose syrups and aspartame. Using a consumer panel it was shown that none of these sweetening systems exhibit a taste profile similar to sucrose. The glucose syrup/aspartame and low-fructose syrup/aspartame mixtures showed statistically significant differences in sweetness, acidity, sweet aftertaste, bitter aftertaste, length of aftertaste, liking for aftertaste, mouthfeel, odour liking, flavour liking and overall liking.

Simon (Simon et al., “Combinations of Glucose Syrups and Intense Sweeteners, Application in Calorie Reduced Soft Drinks” in ‘FIE. Food Ingredients Europe, Conference proceedings, Paris 27, 28, 29 Sep. 1989’, Maarssen, Netherlands; Expoconsult Publishers, 330-333, 1989) recommends using 3% glucose syrup and different combinations of high-intensity sweeteners, which are calculated from a computer model. The high-intensity sweeteners investigated by Simon include acesulfame K, aspartame, cyclamate and saccharin. Simon does not give any sensory description of the resulting taste profiles compared to HFCS 55.

Lotz and Meyer (Lotz, A. Meyer, E., “Sweeteners in Beverages—New Developments”, Food Marketing & Technology, 4-9, 1994.) recommend recipes using sugar and sweetener blends, stating that these combinations create a “nicely balanced sweetness.” Intense sweeteners investigated include acesulfame K, aspartame, cyclamate, saccharin, NHDC, and thaumatin. However, Lotz and Meyer similarly do not provide any sensory results compared to HFCS 55.

McNeil product information broadly discloses that blends of 50% HFCS plus Sucralose in colas are not significantly different in triangle tests from colas sweetened with 100% HFCS only. Neither exact recipes nor the type of HFCS quality is given.

Accordingly, a need remains in the art for sweetener compositions that provide at least a 50% reduction in foodstuff calories and whose resulting foodstuffs sufficiently match the taste profile of foodstuffs containing HFCS 55 alone.

### SUMMARY OF THE INVENTION

The present invention provides such foregoing sweetener compositions, i.e. sweetener compositions that provide at least a 50% reduction in foodstuff calories and whose resulting foodstuffs sufficiently match the taste profile of foodstuffs containing HFCS 55 alone.

The sweetener compositions of the present invention generally include (i) at least one carbohydrate sweetener and (ii) a high intensity sweetener composition formed from a mixture of acesulfame K, aspartame and sucralose.

### DETAILED DESCRIPTION OF TUE INVENTION

The present invention thus provides sweetener compositions used to produce foodstuffs exhibiting a taste profile comparable to HFCS 55 that further advantageously provide a calorie reduction of 50% or more. For the sake of clarity, as used herein, the instant sweetener compositions may also be referred to as “reduced calorie sweetener compositions,” although it is understood that the calorie reduction is actually exhibited within the foodstuff incorporating the instant sweetener compositions.

The sweetener compositions of the present invention generally includes (i) at least one carbohydrate sweetener and (ii) a high intensity sweetener composition formed from a mixture of acesulfame K, aspartame and sucralose.

Neither HFCS 42 or sucrose alone, nor blends of acesulfame K aspartame and sucralose alone match the taste profile of HFCS 55 as such completely. Surprisingly, it was observed that foodstuffs containing (i) at least one carbohydrate sweetener, e.g. either HFCS 55 and/or HFCS 42 and/or sucrose, along with (ii) a high intensity sweetener composition formed from acesulfame K, aspartame and sucralose have a taste profile which is not significantly different from HFCS 55, with a significant caloric reduction in the resulting foodstuff. In advantageous embodiments, the instant sweetener compositions provide significantly more than a 50% calorie reduction in the resulting foodstuff.

The instant reduced-calorie sweetener compositions generally include at least one carbohydrate sweetener and a high intensity sweetener composition formed from a mixture of acesulfame K, aspartame and sucralose.

For the sake of clarity, the high intensity sweetener composition within the reduced-calorie sweetener composition (i.e. the high intensity sweetener composition incorporating acesulfame K, aspartame and sucralose) may be referred to hereinafter as “triple-blend sweeteners” or the like.

Exemplary carbohydrate sweeteners that may be included within the instant reduced-calorie sweetener compositions include HFCS 42, HFCS 55, sucrose, and mixtures thereof. HECS 42, HECS 55 and sucrose are commercially available from numerous sources including Cargill Foods, USA.

The carbohydrate sweetener may advantageously be present within the reduced-calorie sweetener composition in any effective amount.

For example, the carbohydrate sweetener is advantageously present within the reduced-calorie sweetener compositions in non-limiting exemplary amounts ranging from about 96.2 to 99.7 weight percent, based on the weight of the reduced-calorie sweetener composition (“bowsc”), such as amounts ranging from about 98.5 to 99.5 weight percent (bowsc). In particularly advantageous embodiments, the carbohydrate sweetener is present within the reduced-calorie sweetener composition in an amount of about 98.75 to 99.25 weight percent (bowsc).

As noted above, the instant reduced-calorie sweetener compositions further include a high intensity sweetener composition, which may also be referred to as the triple blend sweetener.

As noted above, the triple blend sweetener (also referred to as the high intensity sweetener composition) is a mixture of acesulfame K aspartame and sucralose. Acesulfame K, also referred to as acesulfame potassium, is commercially available as SUNNETT® sweetener from Nutrinova Nutrition Specialties & Food Ingredients GmbH, Germany. Aspartame is commercially available from numerous sources, including the Nutrasweet Company, USA (as NUTRASWEET® artificial sweetener). Sucralose is commercially available as SPLENDA® artificial sweetener from McNeil Nutritionals, USA.

The acesulfame K/aspartame/sucralose composition, i.e. the triple blend sweetener, may contain a wide range of weight ratios. Non-limiting exemplary weight ratios for the acesulfame K:sucralose:aspartame within the high intensity sweetener composition are from 60:30:10 to 40:10:50

The high intensity sweetener composition may be present within the reduced-calorie sweetener composition in any effective amount. The high intensity sweetener composition is advantageously present within the reduced-calorie sweetener compositions in non-limiting exemplary amounts ranging from about 0.3 to 3.8 weight percent (bowsc), such as amounts ranging from about 0.3 to 2.3 weight percent (bowsc), more specifically from about 0.4 to 1.5 weight percent (bowsc) and most specifically from 0.7 to 1.2 weight percent (bowsc).

In addition to the carbohydrate sweetener and the high intensity sweetener composition, the reduced-calorie sweetener compositions and/or resulting foodstuffs of the invention may also contain minor amounts of commonly used additives such as flavors, bulking agents, weighting agents, preservatives and the like. Such commonly used additives may be present in non-limiting exemplary amounts of up to about 10 weight percent, based on the weight of the foodstuff (“bowf”), preferably up to 5 about weight percent (bowf).

The reduced-calorie sweetener compositions of the invention may be incorporated into any foodstuff, including beverages, dairy products, desserts, chewing gums, and the like. Reduced-calorie sweetener compositions in accordance with the invention advantageously result in significantly more than a 50% calorie reduction in comparison to sugar sweetened foodstuffs.

In advantageous embodiments, the reduced-calorie sweetener compositions are included within beverages. Exemplary beverages include all alcoholic beverages and non-alcoholic beverages, either carbonated or non-carbonated, in concentrated form or ready-to drink. Beverages in accordance with the invention may be water based, fruit-juice based, milk- or milk-derivative based. In advantageous embodiments of the invention, the beverages are water based and/or fruit juice based. In especially beneficial aspects of the invention, the beverages are non-alcoholic beverages (water based and/or fruit-juice based), either carbonated or non carbonated, in concentrated form or ready-toe-drink.

The reduced-calorie sweetener compositions may be present within the foodstuff in any effective amount.

The reduced-calorie sweetener composition can be advantageously present within the foodstuff in non-limiting exemplary amounts ranging from about 0.5 to 5.0 weight percent, based on the weight of the foodstuff (bowf), such as from about 1.5 to 5.0 weight percent (bowf). In particularly advantageous embodiments, the reduced-calorie sweetener compositions are present in an amount of about 1.5 to 4.0 weight percent (bowf). This is in contrast to conventional sweeteners, typically included in beverages in amounts of about 10.0 weight percent (bowf).

Considered differently, an exemplary conventional carbohydrate sweetened beverage may contain about 100 g of carbohydrate sweeteners per 1000 ml of beverage. In contrast, an exemplary 1000 ml beverage incorporating the instant sweetener compositions would typically include from about 5.00 to 50.00 g of the reduced-calorie sweetener composition to achieve a taste profile comparable to that of such conventionally sweetened beverages with 100 g of carbohydrate sweetener alone. An exemplary 1000 ml beverage incorporating the instant sweetener compositions would thus typically contain carbohydrate sweetener in amounts ranging from about from about 10 to 50 grams, such as from about 10 to 40 grams, particularly from about 15 to 40 grams. An exemplary 1000 ml beverage incorporating the instant sweetener compositions would typically also include the triple blend sweetener composition in amounts ranging from about 0.02 to 1.0 grams, advantageously from about 0.05 to 0.5 grams, and particularly advantageously from about 0.07 to 0.2 grams.

Conventional beverages may, of course, contain substantially more or less than the 10 wt.-% carbohydrate sweetener noted above. The appropriate amount of the instant sweetener compositions used to provide a taste profile within a beverage of the invention that is comparable to a given conventional beverage sweetened with a specific weight percentage of carbohydrate sweetener alone would thus vary. Generally, the appropriate amount of the sweetener compositions needed to provide a taste profile within a beverage that is comparable to the taste profile of a beverage sweetened with carbohydrate sweeteners alone would be expected to vary proportionally, based on the ranges provided in conjunction with the exemplary 10 wt.-% carbohydrate sweetened 1000 ml beverage discussed above. For example, an exemplary 1000 ml beverage would typically include from about 20.00 to 100.00 g of the reduced-calorie sweetener composition to achieve a taste profile comparable to that of 1000 ml beverages containing 200 g of carbohydrate sweetener alone.

Accordingly, the reduced-calorie sweetener compositions of the invention result in beverages that typically contain about 10 to 50% of the calories of comparable beverages including HFCS 55 alone; such as about 10 to 40% of the calories of comparable beverages including HFCS 55 alone; and particularly from about 15 to 40% of the calories of comparable beverages including HFCS 55 alone.

Reduced-calorie sweetener compositions in accordance with the invention are formed by simply mixing the carbohydrate sweetener(s) (in dry or liquid form) and the high intensity sweeteners (in dry form or as solution) together. The mixing process employed may be any suitable mixing technique known in the food industry. The reduced-calorie sweetener compositions may then be incorporated directly into foodstuffs, using techniques known in the art. In alternative embodiments, the carbohydrate sweetener(s) and/or the high intensity sweeteners may each be added to the foodstuffs separately, i.e. as individual ingredients, or as any of a number of pre-blended intermediate compositions.

As used herein and in the following claims, articles such as “the”, “a” and “an” can connote the singular or plural.

That which is claimed:

1. A reduced-calorie sweetener composition comprising
(i) about 96.2 to 99.7 weight percent, bowsc, of at least one carbohydrate sweetener selected from the group consisting of HFCS 55, HFCS 42 and sucrose; and
(ii) about 0.3 to 3.8 weight percent, bowsc, of a single triple-blend high intensity sweetener composition, said single triple-blend high intensity sweetener composition comprising acesulfame K, aspartame and sucralose, said reduced-calorie sweetener composition imparting a taste profile comparable to HFCS 55.

2. A sweetener composition according to claim 1, wherein the carbohydrate sweetener is present within the reduced-calorie sweetener composition in an amount ranging from about 98.5 to 99.7 weight percent.

3. A sweetener composition according to claim 1, wherein the high intensity sweetener composition is present in the reduced-calorie sweetener composition in an amount ranging from about 0.8 to 1.2 weight percent.

4. A sweetener composition according to claim 1, wherein the high intensity sweetener composition comprises acesulfame K, sucralose and aspartame and the weight ratio of acesulfame K to sucralose to aspartame is 60:30:10 to 40:10:50.

5. A foodstuff incorporating the sweetener composition according to claim 1.

6. A foodstuff according to claim 5, wherein the reduced-calorie sweetener composition is present within the foodstuff in an amount ranging from about 0.5 to 5.0 weight percent, bowf.

7. A foodstuff according to claim 5, wherein the foodstuff is a beverage, dairy product, dessert, or chewing gum.

8. Process for producing a reduced calorie foodstuff, which process comprises incorporating a reduced-calorie sweetener composition into a foodstuff in an amount ranging from about 0.5 to 5.0 weight percent, bowf, said reduced-calorie sweetener composition comprising
(i) at least one carbohydrate sweetener selected from the group consisting of HFCS 55, HFCS 42 and sucrose, said carbohydrate sweetener present within the reduced-calorie sweetener composition in an amount ranging from about 96.2 to 99.7 weight percent, bowsc; and
(ii) a single triple-blend high intensity sweetener composition comprising acesulfame K aspartame and sucralose, the triple-blend high intensity sweetener composition present within the reduced-calorie sweetener composition in an amount ranging from about 0.3 to 3.8 weight percent, bowsc, said foodstuff exhibiting a taste profile comparable to HFCS 55.

9. A process according to claim 8, wherein the carbohydrate sweetener is present within the reduced-calorie sweetener composition in an amount ranging from about 98.7 to 99.3 weight percent.

10. A process according to claim 8 wherein the high intensity sweetener composition is present within the reduced-calorie sweetener composition in an amount ranging from about 0.7 to 1.3 weight percent.

11. A process according to claim 8, wherein the high intensity sweetener composition includes acesulfame K, sucralose and aspartame and the weight ratio of acesulfame K to sucralose and aspartame is 60:30:10 to 40:10:50.

12. A process for producing a reduced-calorie sweetener composition according to claim 1 by mixing the carbohydrate sweetener, acesulfame K, aspartame and sucralose in dry or liquid form.

13. A foodstuff incorporating a sweetener composition according to claim 1, said foodstuff further consisting essentially of
A) a sweetener mixture consisting essentially of
i) at least one carbohydrate sweetener and
ii) the single triple-blend high intensity sweetener composition, and
B) one or more optional additives selected from flavours, bulking agents and weighting agents.
